(19) United States
(12) Patent Application Publication
(10) Pub. No.: US 2002/0199200 A1
(43) Pub. Date: Dec. 26, 2002

(54) System and method for scheduling the distribution of assets from multiple asset providers to multiple receivers

(75) Inventor: Timothy H. Addington, Roswell, GA (US)

Correspondence Address: KING & SPALDING, 191 PEACHTREE STREET, N.E., ATLANTA, GA, 30303-1763, US

(73) Assignee: N2 Broadband, Inc., Duluth, GA

(21) Appl. No.: 10/155,553

(22) Filed: May 24, 2002

Related U.S. Application Data
(60) Provisional application No. 60/293,902, filed on May 25, 2001.

(51) Int. Cl. H04N 7/173

(52) U.S. Cl. 725/97

(57) ABSTRACT

In a system for scheduling the distribution of digital assets by multiple asset providers to multiple receivers, an asset provider can send a request to a scheduler to schedule the distribution of an asset to one or more receivers. The scheduler determines whether the distribution of the asset can be scheduled based upon the availability of the asset provider's resources to distribute the asset and the availability of the receivers' resources to receive the assets. If the resources are not available, the scheduler can attempt to reschedule the distribution of other assets to accommodate the request.

### PRIORITY CLAIM TO PROVISIONAL APPLICATION

This application claims benefit of priority to U.S. Provisional Application Serial No. 60/293,902 entitled “Multi-Catcher Asset Distribution System and Method,” filed May 25, 2001. The subject matter of U.S. Provisional Application Serial No. 60/293,902 is hereby fully incorporated herein by reference.

### TECHNICAL FIELD

The present invention is generally directed to the distribution of media assets by one or more asset providers to receivers for communication to subscribers. More particularly described, the present invention supports the scheduling of the distribution of assets to the receivers by asset providers using a scheduler, where the asset providers and the receivers have finite resources that can be used for the distribution of the assets.

### BACKGROUND OF THE INVENTION

In the digital cable television industry, asset providers, such as Home Box Office (“HBO”), Cable News Network (“CNN”), and the National Broadcasting Company (“NBC”), deliver digital media assets to receivers located at distribution endpoints, such as cable headends, for further distribution to subscribers. In conventional digital cable television systems, the asset provider transmits both the asset and metadata describing the asset to the cable headends, typically via satellite, in a digital data format. The cable headend receives the transmitted assets from the asset provider at a receiver. Typically, each receiver managed by the cable headend receives assets from a particular asset provider. Thus, if a cable headend receives assets from HBO, CNN, and NBC, then the cable headend would manage a first receiver that is dedicated to receiving the assets from HBO, a second receiver that is dedicated to receiving the assets from CNN, and a third receiver that is dedicated to receiving the assets from NBC. In this way, as the cable headends solicit and receive assets from a larger number of asset providers, the number of receivers needed to service the asset providers increases. Thus, using a dedicated receiver for each asset provider can be expensive, it can require large amounts of physical space to house the receivers at the cable headend, and it can result in an inefficient use of each receiver's resources. Specifically, each receiver is typically used only when the asset provider has assets to distribute to the cable headend. If the asset provider only distributes assets to the cable headend once per week, then its dedicated receiver sits idle and unused the remainder of the week.

A limited solution to this problem could be for multiple asset providers to distribute assets to a common receiver. Although such an approach could result in decreased receiver costs and physical space requirements, it also has its limitations. In particular, receivers have limited resources, including a finite processor speed, limited disk storage space, and limited satellite or network connectivity. Consequently, if multiple asset providers are attempting to distribute assets at the same time to one receiver, the receiver may be unable to receive, process, and store the assets. One way the asset providers could increase the likelihood that the assets are actually received by the receiver is by redistributing the assets multiple times per hour to ensure receipt by all receivers. However, such an approach requires extensive manual intervention at the receiver site and results in an inefficient use of valuable transport bandwidth.

Additionally, asset providers could coordinate the scheduling of the distribution of their assets in order to ensure that sufficient receiver resources are available at the time of distribution. Under such an approach, asset providers with competing asset delivery requests could agree to allocate receiver resources among themselves prior to the delivery of their assets. The agreement between the asset providers could then be used to create a resource sharing schedule. A particularly significant drawback to this approach is that it would preclude the dynamic scheduling of asset delivery requests by requiring asset providers to agree on a resource sharing schedule ahead of time. Moreover, the required coordination between multiple asset providers with assets of various sizes, levels of priority, and lifecycles creates inherent complexities in allocating the receiver's resources, it makes the distribution of assets from multiple asset providers extremely difficult to manage, and the resulting resource sharing schedule still may not make the most efficient use of the receiver's resources.

Accordingly, there is a need in the art for a cost-effective method and system for allocating receiver resources among multiple asset providers that allows for dynamic scheduling and rescheduling of asset delivery requests. Furthermore, there is a need in the art for a method and system for allocating receiver resources among multiple asset providers that minimizes manual intervention and promotes the efficient use of available transport bandwidth, physical space, and receiver resources.

### SUMMARY OF THE INVENTION

This invention can allow multiple asset providers to deliver their assets to a common set of receivers by using a scheduler. A network provides a communication path from the asset providers to the receivers and a connection from the scheduler to each of the asset providers and the receivers. The asset delivery path may be a one-way connection such as satellite. The scheduler connection can be a two-way network such as an IP connection. Assets delivered over the asset delivery network may be unicast to a single receiver, multicast to a specific group of receivers, or broadcast to the entire population of receivers.

Table I provides three basic elements in the inventive architecture:

| | |
|---|---|
| Asset Provider | The asset provider can deliver assets to the receivers |
| | when it is instructed to do so by the scheduler. |
| | It typically comprises: |
| | A resource schedule |
| | An asset delivery request queue |
| | An asset delivery schedule |
| Receiver | The receiver can receive the assets from the asset |
| | provider when it is instructed to do so by the scheduler. |
| | It typically comprises: |
| | A resource schedule |
| | An asset receipt schedule |
| Scheduler | The scheduler can determine when a particular asset |
| | provider should deliver a particular asset. |
| | It typically makes this determination based on: |
| | The delivery request queue of all asset providers |
| | The resource schedule of all asset providers |
| | The resource schedule of all receivers |

In one aspect of the present invention, a scheduler has visibility to the asset and resource schedules of all asset providers and receivers. By having a view of the entire network of asset providers and receivers, the scheduler is able to make intelligent scheduling decisions that make maximum use of the resources of the asset providers and receivers. This enables multiple asset providers to efficiently deliver assets to multiple receivers.

Various aspects of the present invention may be more clearly understood and appreciated from a review of the following detailed description of the disclosed embodiments and by reference to the drawings and claims.

### BRIEF DESCRIPTION OF THE DRAWINGS

FIG. 1 is a functional block diagram illustrating exemplary components of a system for scheduling the distribution of assets by multiple asset providers to multiple receivers using a scheduler in accordance with an exemplary embodiment of the present invention.

FIG. 2 is a functional block diagram illustrating components of an asset provider constructed in accordance with an exemplary embodiment of the present invention.

FIG. 3 is a functional block diagram illustrating components of an exemplary receiver constructed in accordance with an exemplary embodiment of the present invention.

FIG. 4 is a functional block diagram illustrating components of an exemplary scheduler constructed in accordance with an exemplary embodiment of the present invention.

FIG. 5 is a logic flow diagram illustrating an exemplary process for scheduling the distribution of assets by multiple asset providers to multiple receivers.

FIG. 6 is a logic flow diagram illustrating an exemplary sub-process or routine of FIG. 5 for attempting to schedule the distribution of a particular asset by an asset provider.

FIG. 7 is an exemplary resource availability matrix built by a scheduler in attempting to schedule the distribution of assets.

FIG. 8 is an exemplary resource availability matrix illustrating the scheduling by a scheduler the distribution of a particular asset.

FIG. 9 is an exemplary resource availability matrix illustrating the rescheduling of scheduled assets by a scheduler to accommodate the distribution of a new asset using the resource availability matrix.

FIG. 10 is an exemplary resource availability matrix illustrating the non-contiguous scheduling of the distribution of an asset by a scheduler.

### DETAILED DESCRIPTION OF EXEMPLARY EMBODIMENTS

Although the illustrative embodiments will be generally described in the context of the cable television industry, those skilled in the art will recognize that the present invention may be implemented in satellite television systems (wherein satellite television providers distribute digital assets directly to satellite set-top boxes located at the homes of subscribers), and in the digital content industry, and for any application in which an asset is distributed to one or more receivers that can receive the asset. More specifically, those skilled in the art will recognize that other exemplary embodiments of the present invention may be implemented for applications in which assets are distributed by asset providers (having finite resources to distribute the asset) to receivers (having finite resources to receive the assets distributed by the asset providers). Moreover, those skilled in the art will also recognize that an asset can comprise any type of media content, including and not limited to MP3 files, digital video files, digital audio or music files, and other digital media and multimedia content.

An exemplary embodiment of the present invention can comprise one or more asset providers that distribute one or more media assets, such as television movies, series, episodes, commercials, or a combination thereof, to one or more exemplary receivers (typically located at cable headends), for further distribution to an audience, such as cable subscribers. An asset provider can comprise any entity that distributes the asset to one or more receivers. The asset providers have a finite number of asset delivery resources with which to distribute the assets to the receivers. Similarly, the receivers have a finite number of resources with which to receive the assets via a communication medium.

An exemplary asset provider can comprise an asset storage device for storing such assets according to an asset identifier that the asset provider uniquely assigns to each asset. The asset provider can access the asset by using the asset identifier as a pointer to locate the asset stored at the asset storage device.

The asset provider typically uses metadata to describe the characteristics or attributes of each asset stored in the asset storage device. For example, an asset provider can use metadata to identify a television program's title, the actors and actresses who appear in the television program, the plot of the program, the program's genre, the television rating of the program, and the viewing time of the program. This metadata is eventually displayed to a cable subscriber through a user interface, such as an electronic cable program guide, and assists a user in selecting a cable television program to view.

The asset provider can use a metadata storage device, typically a digital storage medium, to store metadata and changes or updates to the metadata. An exemplary metadata storage device stores the metadata associated with each asset and the asset identifier that is uniquely assigned to that asset. Each metadata storage device is typically assigned a unique identifier, called a metadata storage device locator, to assist retrieval of metadata maintained by this storage medium.

When the asset provider is prepared to distribute assets to one or more receivers located at distribution endpoints, the asset provider bundles the asset with additional information into an asset bundle for transmission via a communication medium, such as a satellite communications link. The additional information typically comprises the metadata associated with the asset, the asset identifier identifying the asset, and the metadata storage device locator. Each distribution endpoint can receive the asset bundle from the asset provider via the communication medium and can route the asset bundle to an asset manager. After unbundling the asset bundle, the asset manager stores the asset and the asset identifier received from the asset provider in an exemplary asset storage device. Additionally, the asset manager typically stores the metadata describing the asset and the asset identifier identifying the asset in an exemplary metadata cache at the distribution endpoint.

Before distributing the asset to one or more receivers located at the distribution endpoints, the asset provider can request an exemplary scheduler to schedule the distribution of the asset. In response to the request, the scheduler can determine the best delivery time and resources for an asset provider to use to distribute the asset to a receiver. The scheduler can compute this schedule based upon asset provider and receiver resources, as well as the asset delivery requests received from other asset providers, and any service level agreements that are in place for the receivers and asset providers. For example, if a previously scheduled distribution of assets conflicts with the requested delivery, the scheduler can attempt to reschedule previously scheduled assets to accommodate the current request. The scheduler can then inform all asset providers and receivers of the rescheduling changes so that the current request is accommodated.

Referring now to the drawings in which like numerals represent like elements throughout the several figures, exemplary embodiments of the present invention and the illustrative operating environment will be described.

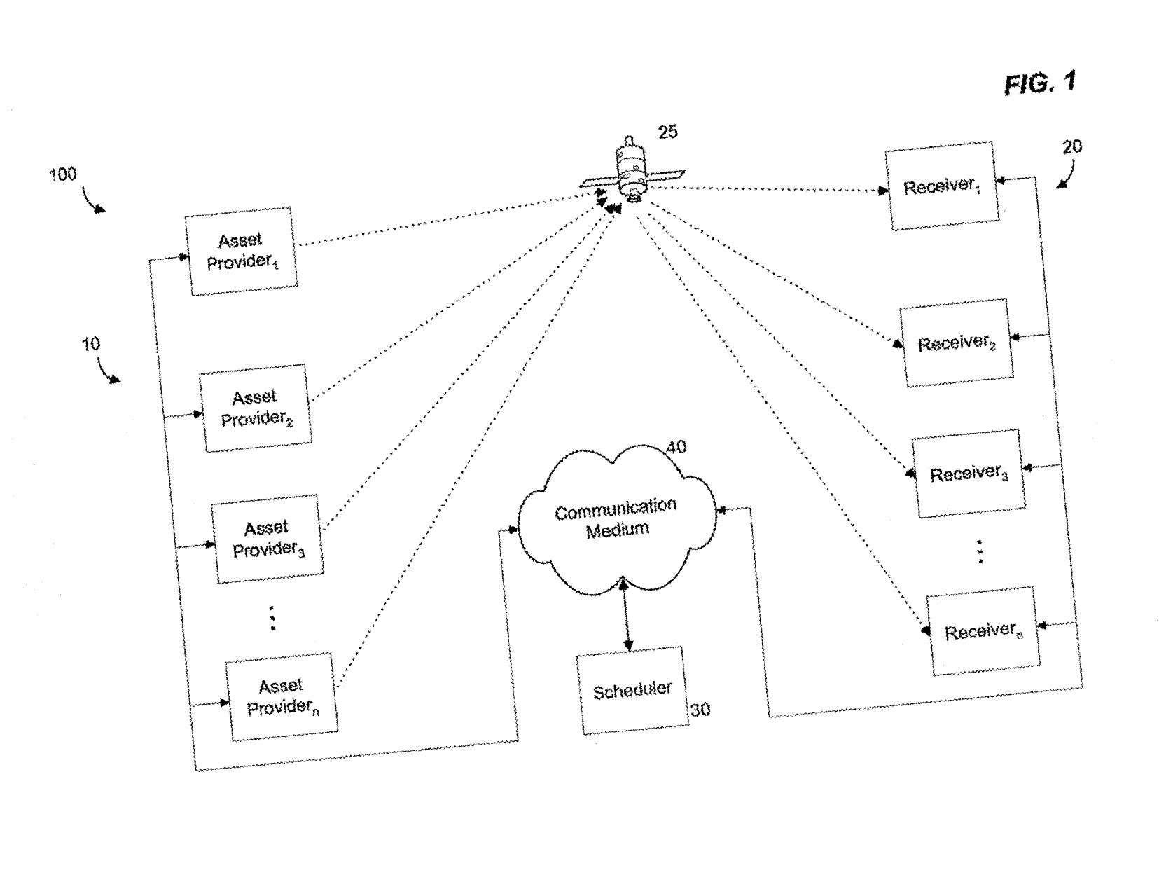

FIG. 1 is a functional block diagram illustrating exemplary components of a system 100 for scheduling the distribution of assets by multiple asset providers 10 to multiple receivers 20 using a scheduler 30 in accordance with an exemplary embodiment of the present invention. Though individual components are illustrated in the exemplary embodiment of FIG. 1, multiple components can be employed without departing from the scope and spirit of the present invention.

The exemplary system 100 can comprise one or more asset providers 10 and receivers 20 coupled to a communications medium 40 and operative to communicate with a satellite 25. Asset providers 10 with a finite number of asset delivery resources can distribute assets to the receivers 20 over various types of network technologies. The asset providers 10 can distribute assets to the receivers 20 via the satellite 25 or an alternative communications link using a broadcast, multicast, or unicast communications methodology. One or more schedulers 30 can control the asset providers 10. For example, the asset provider 10 can maintain a resource schedule that the scheduler 30 uses to determine when the asset may be sent from an asset provider 10. The asset provider 10 can also maintain an asset provider delivery request queue that comprises a list of assets that have been sent to the scheduler 30 to be assigned delivery resources. The asset provider 10 can further maintain an asset provider delivery schedule that comprises a list of assets that have been scheduled for delivery.

Receivers 20 with a finite number of available resources receive assets from one or more asset providers 10. In one exemplary embodiment, a receiver 20 receives assets from multiple asset providers 20 via multiple satellite transponders at varying times. In another exemplary embodiment, a receiver 20 receives assets from multiple asset providers 20 via multiple satellite transponders concurrently. In other exemplary embodiments, the receiver 20 can comprise multiple receivers 20, or the receiver 20 can receive assets from other receivers 20 via an IP or other communication network, or the receiver 20 can comprise multiple receivers 20 and receive assets from other receivers 20 via a communication network. Regardless of how the receivers 20 receive the assets, they are typically under the control of one or more schedulers 30. The receiver 20 typically maintains a receiver resource schedule that the scheduler 30 uses to determine when an asset may be sent to the receiver 20.

As shown in FIG. 1, a scheduler 30 can control asset providers 10 and receivers 20 to support the distribution of assets from the asset providers 10 to each selected receiver 20. Using task scheduling algorithms well known in the art, such as the algorithm disclosed in U.S. Pat. No. 5,619,695 entitled “Method and Apparatus for Scheduling Resources,” issued Apr. 8, 1997, the scheduler 30 can determine the best delivery time and resources for an asset provider 10 to use to distribute an asset to a receiver 20. For example, the scheduler 30 can use a scheduling algorithm to schedule the distribution of an asset to a receiver, taking into account the availability of the resources of the asset provider 10 and the receivers 20, as well as the asset delivery requests received from the asset providers 10, and any service level agreements (which may specify scheduling and resource priorities among the asset providers and the receivers) that are in place for the asset providers 10 and receivers 20.

Asset Providers

The asset providers 10 are responsible for delivering the assets to the receivers 20. The method of delivery may be unicast, multicast, or broadcast. The networks and protocols used to deliver the assets are relevant in the design of this system only inasmuch as the scheduler 30 knows the capabilities of these components in order to determine a delivery schedule.

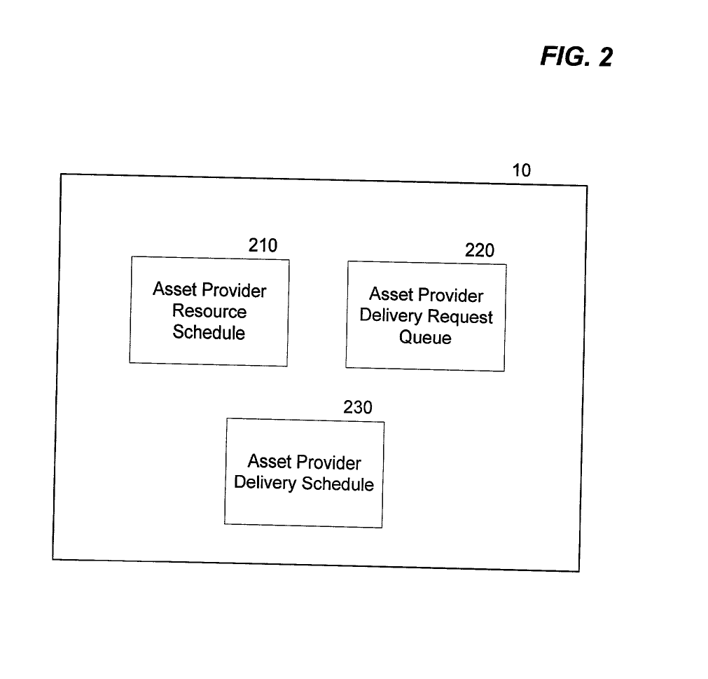

FIG. 2 is a functional block diagram illustrating components of an exemplary asset provider 10 constructed in accordance with an exemplary embodiment of the present invention. For example, the asset provider 10 can comprise components useful for determining when and how assets are delivered:

Asset Provider Resource Schedule 210

Asset Provider Delivery Request Queue 220

Asset Provider Delivery Schedule 230

Asset Provider Resource Schedule

The asset provider resource schedule 210 can comprise a list of resources that the asset provider 10 has available for the delivery of an asset over a period of time. Resources typically comprise delivery bandwidth, such as the data rate available over a satellite transponder at any given time, and asset bandwidth, such as the amount of data that it can retrieve at a particular time. For instance, an asset provider 10 may have the ability to send 45 Mb/s over a satellite 25 but be limited to 7.5 Mb/s because it only has access to an asset over a 10baseT network at that time. Additionally, an asset provider 10 may have multiple resources available at any given time. For instance, an asset provider 10 may be able to transmit over four different transponders simultaneously at a particular time.

As is understood by those skilled in the art, not all asset provider 10 resources may be able to access all receivers 20. That is, of the four transponders in the previous example, it is possible that only half of the receivers 20 are able to tune to two of the transponders and the other half are able to tune to all of them. Also, resources available to an asset provider 10 may vary over time. An asset provider 10 may have a full transponder available to it at 45 Mb/s for an hour and then not at all for several hours after that.

Generally, it can be the responsibility of the asset provider 10 to maintain the provisioning of the asset provider resource schedule 210. The asset provider resource schedule 210 can reflect physical hardware and business arrangements such as leased transponder space and network bandwidth. Any time the asset provider resource schedule 210 is updated, a message can be sent to the scheduler 30 with the new schedule. The scheduler 30 may also request the asset provider resource schedule 210 from the asset provider 10 for audit and synchronization purposes.

An asset provider 10 can be shared among multiple schedulers 30. When an asset provider 10 is shared among multiple schedulers 30, it can be the responsibility of the asset provider 10 to allocate its resources among the schedulers 30. The asset provider resource schedule 210 sent to a scheduler 30 should reflect only those resources that are controlled by that scheduler 30.

Asset Provider Delivery Request Queue

The asset provider delivery request queue 220 typically comprises a list of the assets that need to be scheduled for delivery. An entry in this queue can comprise:

Asset Information, comprising the location and size of the asset to be delivered.

Availability Time, comprising the time at which the asset becomes available for delivery.

Delivery Time, comprising the time by which the asset must be delivered to the receivers 20.

Receiver List, comprising the one or more receivers 20 or Receiver Groups to which the asset is to be delivered.

Optional Criteria, comprising additional information that the scheduler 30 may use to determine when to schedule the delivery of the asset. This may comprise a preferred transport stream, delivery time, bit rate, or other parameters.

The asset provider 10 is responsible for updating the asset provider delivery request queue 220. When an item is added to the asset provider delivery request queue 220, deleted from the asset provider delivery request queue 220, or modified in the asset provider delivery request queue 220, the asset provider 10 can send an “asset provider asset schedule request” message to the scheduler 30 notifying it of the asset provider delivery request queue 220 update.

Asset Provider Delivery Schedule

When the asset provider 10 has an asset in its asset provider delivery request queue 220, it sends a “delivery request” message to the scheduler 30. The scheduler 30 then determines the best time and resources for the asset provider 10 to use to deliver the asset. When the scheduler 30 has recalculated the delivery schedule, it sends an “asset delivery schedule update” message to the asset provider 10. This message tells the asset provider 10 when to deliver the asset and the resources to use to deliver the asset. The asset provider 10 can store the message in its asset provider delivery schedule 230.

When the scheduler 30 calculates a delivery schedule, it may have to reschedule other assets that have already been scheduled. Since the receiver resources are shared among multiple asset providers 10, the scheduler 30 may have to reschedule asset delivery for asset providers 10 that did not send the asset delivery request. For this reason, an asset provider 10 must always listen for “asset delivery schedule update” messages from the scheduler 30.

An “asset delivery schedule update” message typically comprises a list of all asset delivery requests that the scheduler 30 knows about for that asset provider 10. The possible delivery states for an asset delivery request comprise:

A “Scheduled” state, which means that the scheduler 30 has determined a delivery time and a set of resources that the asset provider 10 should use to deliver the asset.

The “Pending” state, which means that the scheduler 30 has received the request but has not yet determined the parameters for the asset provider 10 to deliver the asset.

The “Rejected” state, which means that the scheduler 30 has received the request and has determined that the asset cannot be delivered by the requested time with the resources available.

The “Paused” state, which means that the delivery of an asset is temporarily suspended. In other words, the asset provider 10 should stop sending the asset until the Pause state is removed from the asset. It should be noted that some transport mechanisms might not support the pausing of asset transmission. The pause mechanism must be supported by the asset provider 10 and by all the receivers 20 that are scheduled to receive the asset before the scheduler 30 can put an asset transmission in the Paused state.

The “Terminated” state, which means that the delivery of an asset has been permanently halted. In other words, the asset providers 10 should stop sending the asset and return it to the Pending state, and should await a new delivery schedule.

It is particularly important to note that once an asset has been placed in the Scheduled state for delivery, it may be returned back to the Pending state by the scheduler 30.

When the scheduler 30 gets an updated asset provider resource schedule 210 from the asset providers 10 and receivers 20 or new asset delivery requests from an asset provider 10, it can recalculate the delivery schedule for all asset providers 10. It is possible that due to lack of resources or the scheduling of a higher priority asset, an asset delivery that was previously scheduled may no longer be accommodated at all. As a last resort, the scheduler 30 may stop the transmission of an asset that is already underway to accommodate a more urgent request.

In these cases, the asset provider 10 must return the asset status to the Pending or Rejected state. It is not necessary to resubmit the delivery request to the scheduler 30 for an asset that is in the Pending state unless the queue information for that asset has changed. If the scheduler 30 places an asset in the Rejected state, the asset provider 10 must modify the delivery request parameters and re-submit it to the scheduler 30.

An asset provider 10 may modify or delete an asset that has been scheduled by sending an “asset provider asset schedule request” message. If the scheduled asset is currently being sent, the asset provider 10 should stop sending the asset before deleting it from the scheduler 30. If the asset provider 10 is requesting to modify an asset that is currently being sent, it continues sending the asset until notified of any changes by the scheduler 30.

Receivers

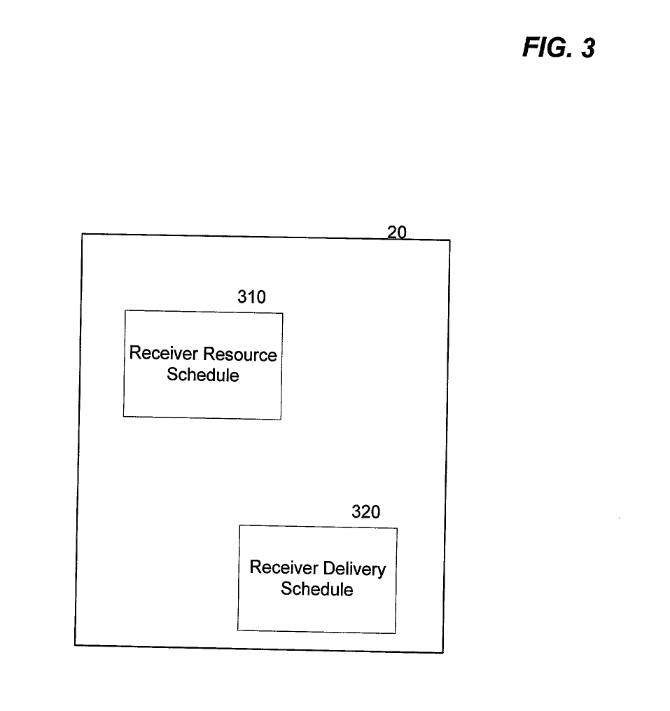

FIG. 3 is a functional block diagram illustrating components of an exemplary receiver 20. An exemplary receiver 20 comprises two components that can be used to determine when and how asset is received:

Receiver Resource Schedule 310

Receiver Delivery Schedule 320

Receiver Resource Schedule

The receiver resource schedule 310 can comprise a list of resources that the receiver 20 has available for the receipt of an asset over a period of time. Each receiver 20 of the asset distribution system 100 may have a different resource configuration. Receiver resources may comprise the number of simultaneous transmissions a receiver 20 can receive, the amount of asset storage of the receiver 20, the number of asset providers 10 it is able to receive from, the transponder bandwidth, the disk capacity available at any given time, asset bandwidth, such as the maximum amount of data that the receiver 20 can handle at a particular time, and other factors that may affect the ability of the receiver 20 to receive an asset.

For instance, a receiver 20 may have the ability to receive 45 Mb/s over a satellite 25 but be limited to 10 Mb/s because of internal processing limitations. Additionally, a receiver 20 may have multiple resources available at any given time. For instance, a receiver 20 may be able to receive from four different transponders simultaneously at a particular time.

Generally, a receiver 20 maintains the provisioning of the receiver resource schedule 310. The receiver resource schedule 310 can reflect physical hardware and networking arrangements, such as the number of receivers 20 and disk capacity. Any time the receiver resource schedule 310 is updated, the receiver 20 can send a message to the scheduler 30 with the new schedule. The scheduler 30 may also request the receiver resource schedule 310 from the receiver 20 for audit and synchronization purposes.

When a receiver 20 is shared among multiple schedulers 30, the receiver 20 can allocate its resources among the schedulers 30. The receiver resource schedule 310 sent to a scheduler 30 reflects only those resources that are controlled by that scheduler 30.

Receiver Delivery Schedule

The receivers 20 can be provisioned with a receiver delivery schedule 320, which typically comprises the assets that are going to be delivered from the various asset providers 10. The receiver delivery schedule 320 can comprise a list of assets that a receiver 20 is scheduled to receive over a period of time. Each asset in the receiver delivery schedule 320 can comprise the time of delivery and resources that are required to receive the asset.

An exemplary scheduler 30 maintains the receiver delivery schedule 320. The scheduler 30 can maintain the receiver delivery schedule 320 by sending a “receiver delivery schedule update” message to the receiver 20. This message comprises a list of all assets that a receiver 20 is scheduled to receive.

If multiple schedulers 30 control a receiver 20, the “delivery schedule update” message comprises only the assets that were scheduled by the scheduler 30 that sent the message. In this case, the receiver 20 can provide an internal mechanism for tracking which asset is scheduled by a particular scheduler 30 because scheduled assets may be deleted in a subsequent message.

Schedulers

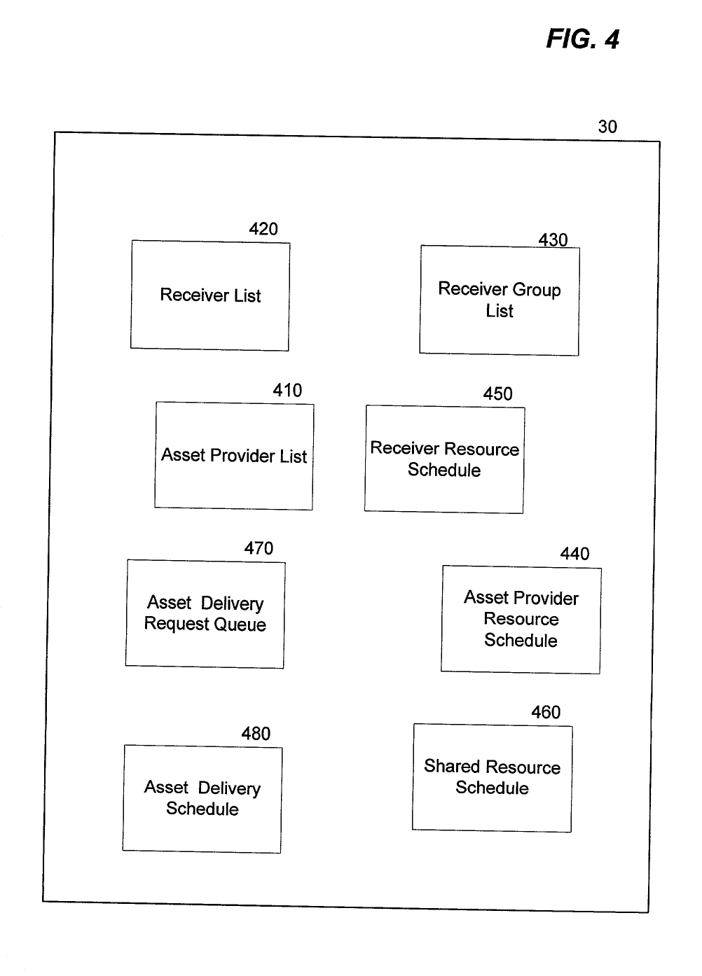

FIG. 4 is a functional block diagram illustrating components of an exemplary scheduler 30. An asset delivery distribution network according to one embodiment of the invention includes one or more schedulers 30. A scheduler 30 is responsible for determining which asset provider 10 can send its asset to one or more receivers 20 at a given time using a specified set of resources from the asset provider 10 and receivers 20.

An exemplary scheduler 30 maintains the following information in order to determine which asset is delivered:

Asset Provider List 410

Receiver List 420

Receiver Group List 430

Asset Provider Resource Schedule 440

Receiver Resource Schedule 450

Shared Resource Schedule 460

Asset Delivery Request Queue 470

Asset Delivery Schedule 480

Asset Provider List

The asset provider list 410 comprises a list of all asset providers 10 that are managed by the scheduler 30. The asset provider list 410 can also comprise the addressing information that is necessary for the scheduler 30 to communicate with each asset provider 10.

Generally, the asset provider list 410 can be maintained by the scheduler 30. However, another exemplary embodiment of the invention can comprise an auto registration procedure, which could be used for asset providers 10 to locate the scheduler 30 and register their addresses without a need for manual configuration.

The exemplary scheduler 30 maintains an administrative and operational status of the asset providers 10 in the asset provider list 410. The scheduler 30 can operate only with asset providers 10 that are in the list with an administrative status of “enabled” and an operational status of “on-line.”

Receiver List

The receiver list 420 comprises a list of receivers 20 that are managed by the scheduler 30. The receiver list 420 also can comprise the addressing information that can be used by the scheduler 30 to communicate with the receiver 20.

Generally, the receiver list 420 can be maintained by the scheduler 30. However, in another exemplary embodiment of the present invention, an auto registration procedure could be used by the receivers 20 to locate the scheduler 30 and register their addresses without a need for manual configuration.

The exemplary scheduler 30 maintains an administrative and operational status of the receivers 20 in the receiver list 420. The scheduler 30 can operate with receivers 20 that are in the receiver list 420 with an administrative status of “enabled” and an operational status of “on-line.”

Receiver Group List

The receiver group list 430 allows an asset provider 10 to treat receivers 20 as a group rather than having to specify each individual receiver 20. When an asset provider 10 sends a request to schedule the delivery of an asset, the request can comprise the one or more receivers 20 to which the asset is to be delivered. However, if the asset provider 10 groups the receivers 20 into one or more groups in the receiver group list 430, then the asset provider 10 can specify a single receiver group in the request.

A receiver 20 can be placed in as many or few receiver groups as needed. In other words, a receiver group may comprise as few as zero receivers 20 up to all receivers 20. When a receiver 20 is removed from the receiver list 420, it is also removed from all receiver groups that it has been assigned to.

The exemplary scheduler 30 maintains the receiver group list 430, while the asset provider 10 can provision itself with the receiver group list 430.

Asset Provider Resource Schedule

The asset provider resource schedule 440 is similar to the asset provider resource schedule 210 that is maintained by the asset provider 10. The exemplary scheduler 30 maintains an asset provider resource schedule 440 for each asset provider 10 in the asset provider list 410. The scheduler 30 requests the asset provider resource schedule 210 from the asset provider 10 the first time that the asset provider 10 sends it an “asset delivery request” message, unless the asset provider 10 has already sent a “resource schedule update” message. The asset provider 10 is typically responsible for notifying the scheduler 30 any time the asset provider resource schedule 210 for resources under the control of that scheduler 30 are changed. The scheduler 30 may request an asset provider resource schedule 210 from an asset provider 10 at any time for audit or synchronization purposes.

The asset provider resource schedule 440 comprises a list of resources that are available on the asset provider 10 and the time that resource is available. Any change to an asset provider resource schedule 440 results in a new entry in the resource schedule 440. For instance, if an asset provider 10 has a transponder resource of 10 Mb/s available from 00:00:00 to 18:00:00 and only 5 Mb/s available from 18:00:00 to 00:00:00, this would result in two entries in the asset provider resource schedule 440. The first entry would be for a transponder of 10 Mb/s from 00:00:00 to 18:00:00 and the second entry would be for a transponder of 5 Mb/s from 18:00:00 to 00:00:00.

Resource schedule entries can comprise repeat notations. That is, a resource schedule entry may be set to repeat daily, weekly, or some other period of time. Repeated resource schedules may be set to repeat forever or may be limited to a number of repetitions. All resource schedule entries can comprise a start time and end time for that resource availability. For resources that are always available, the start time and end time of the resource can be the same (i.e.: 00:00:00 to 00:00:00) and set to repeat forever.

Resource definitions are extensible. The scheduler 30 defines the resource template, and new resources may be added at any time. Resource definitions can be expressed using Extensible Markup Language (“XML”). However, in other embodiments of the present invention, other computer programming languages can be used to express the resource definitions. Each resource type has a resource identifier to distinguish it from all other types. The resource schedulers 30 use the resource type to determine the fields that describe the resource.

For instance, a transponder uses a transponder resource. The dictionary for the transport stream resource could comprise the following elements:

ResourceType: transponder

StartTime: 00:00:00

EndTime: 00:00:00

Repeat: daily forever

TransponderId: Galaxy3R_TP1

DataRate: 10 MBS

Only the ResourceType element is required in the resource definition. Depending on the resource, some elements can have default values that are used if the element is not supplied. The StartTime, EndTime, and Repeat elements can be defined for every resource type. If a resource is available all of the time, these elements do not have to be included in the XML.

In the above example, the resource specifies 10 Mb/s available all of the time on the Galaxy 3R satellite Transponder 1. The following definition would produce the same resource definition:

ResourceType: transponder

TransponderId: Galaxy3R_TP1

DataRate: 10 MBS

Before an asset provider 10 or receiver 20 can use a resource template, it is preferably defined in the scheduler 30.

Receiver Resource Schedule

This receiver resource schedule 450 is similar to the receiver resource schedule 310 that is maintained by the receiver 20. The exemplary scheduler 30 maintains a receiver resource schedule 450 for each receiver 20 in the receiver list 420. The scheduler 30 can request the receiver resource schedule 310 from the receiver 20 the first time that an asset is requested to be sent to that receiver 20, unless the receiver 20 has already sent a “resource schedule update” message. The receiver 20 is responsible for notifying the scheduler 30 any time the receiver resource schedule 310 for resources under the control of that scheduler 30 have been changed. The scheduler 30 may request a resource schedule 310 from a receiver 20 at any time for audit or synchronization purposes.

The receiver resource schedule 450 typically comprises a list of resources that are available on the receiver 20 and the time that resource is available. Any change to a receiver resource schedule 450 results in a new entry in the resource schedule 450. For instance, if a receiver 20 has a satellite receiver resource of 45 Mb/s available from 00:00:00 to 06:00:00 and from 15:00:00 to 18:00:00, this would result in two entries in the resource schedule. The first entry would be for a receiver 20 of 45 Mb/s from 00:00:00 to 06:00:00 and the second entry would be for a receiver 20 of 45 Mb/s from 15:00:00 to 18:00:00.

Resource schedule entries may contain repeat notations. That is, a resource schedule entry may be set to repeat daily, weekly, or some other period of time. Repeated resource schedules may be set to repeat forever or may be limited to a number of repetitions. All resource schedule entries can comprise a start time and end time for that resource availability. For resources that are always available, the start time and end time of the resource can be the same (i.e.: 00:00:00 to 00:00:00) and set to repeat forever.

Resource definitions are extensible. The scheduler 30 defines the resource template and new resources may be added at any time. Resource definitions can be expressed using XML or in any other computer programming language. Each resource type can have a resource identifier to distinguish it from all other types. The resource schedulers 30 use the resource type to determine the fields that describe the resource.

For instance, a satellite receiver 20 uses an Lband resource. The dictionary for the Lband resource would contain the following elements:

ResourceType: Lband

StartTime: 00:00:00

EndTime: 00:00:00

Repeat: daily forever

TransponderId: Galaxy3R_VH

DataRate: 45 MBS

Only the ResourceType element is required in the resource definition. Depending on the resource, some elements can have default values that are used if the element is not supplied. The StartTime, EndTime, and Repeat elements are preferably defined for every resource type. If a resource is available all of the time, these elements do not have to be included in the XML. In the above example, the resource specifies 45 Mb/s available all of the time on the Galaxy 3R satellite Vertical and Horizontal polarization. The following definition would produce the same resource definition:

ResourceType: Lband

TransponderId: Galaxy3R_VH

In this case the DataRate element does not have to be defined since the default is that the resource can receive a full feed from the transponder.

Before an asset provider 10 or receiver 20 can use a resource template, the resource must be defined in the scheduler 30.

Shared Resource Schedule

The shared resource schedule 460 typically comprises a list of all of the resources that the scheduler 30 has available to it over a period of time. These resources can be shared among multiple asset providers 10. The exemplary scheduler 30 uses the shared resource schedule 460 to determine the most efficient schedule for satisfying all of the outstanding asset delivery requests.

The exemplary scheduler 30 maintains the shared resource schedule 460. Resources in the shared resource schedule 460 can be determined based on physical availability, business agreements, and other factors. For instance, multiple asset providers 10 may share a transponder, but one asset provider 10 may have priority access to the transponder. In this case, if that asset provider 10 submits a request to deliver an asset, the scheduler 30 may delay previously scheduled assets by other asset providers 10 to ensure that the asset gets out.

The resources in the shared resource schedule 460 define the total resources that the scheduler 30 controls. The individual asset providers 10 and receivers 20 can maintain their own resource schedules 210, 310 and those schedules 210, 310 override the available resources in the shared resource schedule 460. For instance, the shared resource schedule 460 may indicate that a transponder has 10 Mb/s available to an asset provider 10 from 02:00:00 to 04:00:00. The asset provider resource schedule 210 from that asset provider 10 may indicate that the asset provider 10 can only deliver 5 Mb/s during that time period. In this case, the scheduler 30 must accept the asset provider's 10 resource schedule 210 and will only schedule assets to be delivered at the 5 Mb/s rate. On the other hand, the scheduler 30 will limit the resources to those imposed by its shared resource schedule 460. In the above example, if the shared resource schedule 460 indicated that 5 Mb/s was available on the transponder but the asset provider's 10 resource schedule 210 said that it could deliver 10 Mb/s at that time, the scheduler 30 would limit the asset provider's 10 transmission to 5 Mb/s.

Asset Delivery Request Queue

The asset delivery request queue 470 typically comprises an entry for each asset that has an outstanding delivery request from all of the asset providers 10 that are managed by the scheduler 30. The asset delivery request queue 470 is maintained by the exemplary scheduler 30 and can be updated as a result of an asset delivery request and asset delivery notification messages received from the asset providers 10.

Asset Delivery Schedule

The asset delivery schedule 480 typically comprises all of the asset requests that have been scheduled for delivery. The entries in the asset delivery schedule 480 comprises the resources that are allocated for the delivery of the asset and the start and stop times that they are allocated.

Multiple Schedulers

In another exemplary embodiment of the present invention, multiple schedulers 30 may be used to control the same asset providers 10 and receivers 20. Each scheduler 30 can operate independently and have no knowledge of the other schedulers 30. It can be the responsibility of the asset providers 10 and receivers 20 to allocate their resources between the different schedulers 30. The asset provider 10 can be responsible for sending the asset delivery requests to the correct scheduler 30 in this type of network. Any messages containing requests, resources, or schedules should comprise only those items that apply to the scheduler 30 that is controlling them.

Scheduler Messages

All scheduling messages in the network are sent between the scheduler 30 and the asset provider 10 or the scheduler 30 and the receiver 20.

Provision Receiver Message

The “provision receiver” message comprises an administrative message and can typically be sent from an administrative console. It can be used to add, delete, or modify a receiver record in the receiver list 420. The scheduler 30 uses these records to communicate with the receivers 20.

Provision Asset Provider Message

The “provision asset provider” message comprises an administrative message and can be typically sent from an administrative console. It can be used to add, delete, or modify an asset provider record in the asset provider list 410. The scheduler 30 uses these records to communicate with the asset providers 10.

Provision Scheduler Message

The “provision scheduler” message comprises an administrative message and may be sent from an administrative console. It can be used to provision an asset provider 10 or receiver 20 with the information required to communicate with the scheduler 30. Typically, the asset providers 10 and receivers 20 are provisioned with the address of the scheduler 30 through a network directory service such as DNS, so this message is not required unless the address of the scheduler 30 changes. In this case, it may be desirable to notify the asset providers 10 and receivers 20 of the change rather than to lose communications for the period of time that is required to discover the new address of the scheduler 30.

Get Asset Provider Resource Schedule Message

The “get asset provider resource schedule” message can be sent from the scheduler 30 to an asset provider 10 to get the current asset provider resource schedule 210 of available asset provider resources. This message comprises criteria to limit the amount of the asset provider resource schedule 210 that is returned to the scheduler 30 in the reply. Under normal operating conditions, the asset provider 10 can be responsible for creating the asset provider resource schedule 210. The scheduler 30 uses the information returned from this request to determine what resources are available for the delivery of assets. These resources are allocated and the assets are scheduled for delivery. If multiple schedulers 30 control the asset provider 10, then the asset provider 10 can allocate its resources among the schedulers 30. An exemplary asset provider 10 reports only the resources that are available to the requesting scheduler 30 in response to a get asset provider resource schedule message.

Asset Provider Update Resource Schedule Message

The “asset provider update resource schedule” message can be sent from an asset provider 10 to the scheduler 30 when the asset provider resource schedule 210 is changed. The scheduler 30 uses this message to update its asset provider resource schedule 440. As a result of this message, the scheduler 30 can restructure the asset delivery schedules 480 for all asset providers 10 to accommodate or take advantage of the new resource schedule 440. As a result of this message, those assets that were previously scheduled to be delivered may no longer have the available resources. As a result, a restructured asset delivery schedule 480 may be created which does not comprise previously scheduled assets. When new asset delivery schedules 480 are received, it can be the responsibility of the asset provider 10 or receiver 20 to determine if an asset has been removed.

Receiver Update Resource Schedule Message

The “receiver update resource schedule” message can be sent from a receiver 20 to the scheduler 30 when the receiver resource schedule 310 is changed. The scheduler 30 uses this message to update its receiver resource schedule 450. As a result of this message, the scheduler 30 may restructure the asset delivery schedules for all asset providers 10 to accommodate or take advantage of the new receiver resource schedule 450. As a result of this message, assets that were previously scheduled to be delivered may no longer have the available resources. A restructured asset delivery schedule 480 may be created that does not comprise previously scheduled assets. When new asset delivery schedules 480 are received, it is the responsibility of the asset provider 10 or receiver 20 to determine if asset has been removed.

Get Asset Provider Asset Schedule Message

The “get asset provider asset schedule” message can be sent from the scheduler 30 to an asset provider 10 to get the current schedule of assets to be delivered. This message comprises criteria to limit the amount of the asset provider delivery schedule 230 that is returned to the scheduler 30 in the reply. Under normal operating conditions, the scheduler 30 is responsible for creating the asset delivery schedule 480. This message is provided as a mechanism for the scheduler 30 to perform audits of the system or to resynchronize the schedules when the scheduler 30 is restarted. An asset provider 10 reports the asset provider delivery schedule 230 for the asset that was scheduled by the requesting scheduler 30 in response to a get asset provider asset schedule message.

Get Receiver Resource Schedule Message

The “get receiver resource schedule” message can be sent from the scheduler 30 to a receiver 20 to get the resource schedule 310 of a receiver 20. This message comprises criteria to limit the amount of the receiver resource schedule 310 that is returned to the scheduler 30 in the reply. Under normal operating conditions, the receiver 20 is responsible for maintaining its receiver resource schedule 310. If a single scheduler 30 controls a receiver 20, the receiver resource schedule 310 is typically fixed for that receiver 20 and the scheduler 30 can be free to allocate the receiver resources as required. If multiple schedulers 30 control the receiver 20, then the receiver 20 allocates those resources between the schedulers 30. A receiver 20 should only report the resources that are available to the requesting scheduler 30 in response to a get receiver resource schedule message.

Get Receiver Asset Schedule Message

The “get receiver asset schedule” message can be sent from the scheduler 30 to a receiver 20 to get the current schedule of assets 320 to be received. This message contains criteria to limit the amount of the receiver delivery schedule 320 that is returned to the scheduler 30 in the reply. Under normal operating conditions, the scheduler 30 is responsible for creating the receiver delivery schedule 320. This message is provided as a mechanism for the scheduler 30 to perform audits of the system or to resynchronize the schedules when the scheduler 30 is restarted. A receiver 20 reports the receiver delivery schedule for assets that were scheduled by the requesting scheduler 30 in response to a get receiver asset schedule message.

Asset Provider Asset Schedule Request Message

The “asset provider asset schedule request” message can be sent from an asset provider 10 to a scheduler 30 to add, modify, or delete one or more scheduled asset deliveries. This message is sent whenever the asset provider 10 makes a change to its asset provider delivery schedule 230. The scheduler 30 determines if the requested changes can be accommodated within the bounds of the asset provider's 10 service level agreements. If the schedule change can be accommodated, the scheduler 30 accepts the changes and updates the asset delivery schedule 480 on any affected asset providers 10 including the requesting asset provider 10 and the delivery schedule on any affected receivers 20. The requesting asset provider 10 should not update its asset provider delivery schedule 230 as a result of a positive response to this message. Instead, this asset provider 10 should wait for an “asset provider asset schedule update” message from the scheduler 30. If the request cannot be accommodated, the request is denied and no schedules are changed.

Asset Provider Delivery Notification Message

The “asset provider delivery notification” message can be sent from the asset provider 10 to the scheduler 30 when the delivery of an asset completes. The scheduler 30 uses this message to free the resources used by the asset provider 10 and receivers 20.

Asset Provider Delivery Schedule Update Message

The asset provider delivery schedule update message can be sent from the scheduler 30 to an asset provider 10 to update one or more scheduled asset deliveries in the receiver delivery schedule 320. This message is sent whenever the scheduler 30 adjusts the asset delivery schedule 480 to accommodate a new asset delivery request from an asset provider 10.

Receiver Delivery Schedule Update Message

The “receiver delivery schedule update” message can be sent from the scheduler 30 to a receiver 20 to update one or more asset delivery schedule 320 entries. This message is sent whenever the scheduler 30 adjusts the asset delivery schedule 480 to accommodate a new asset delivery request from an asset provider 10.

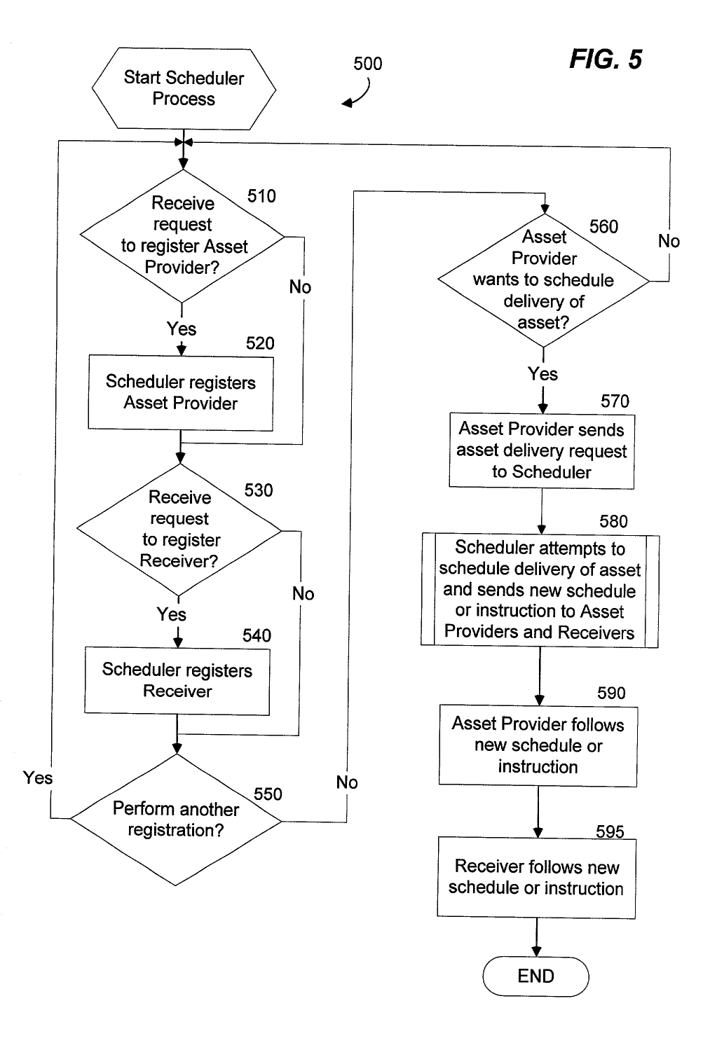

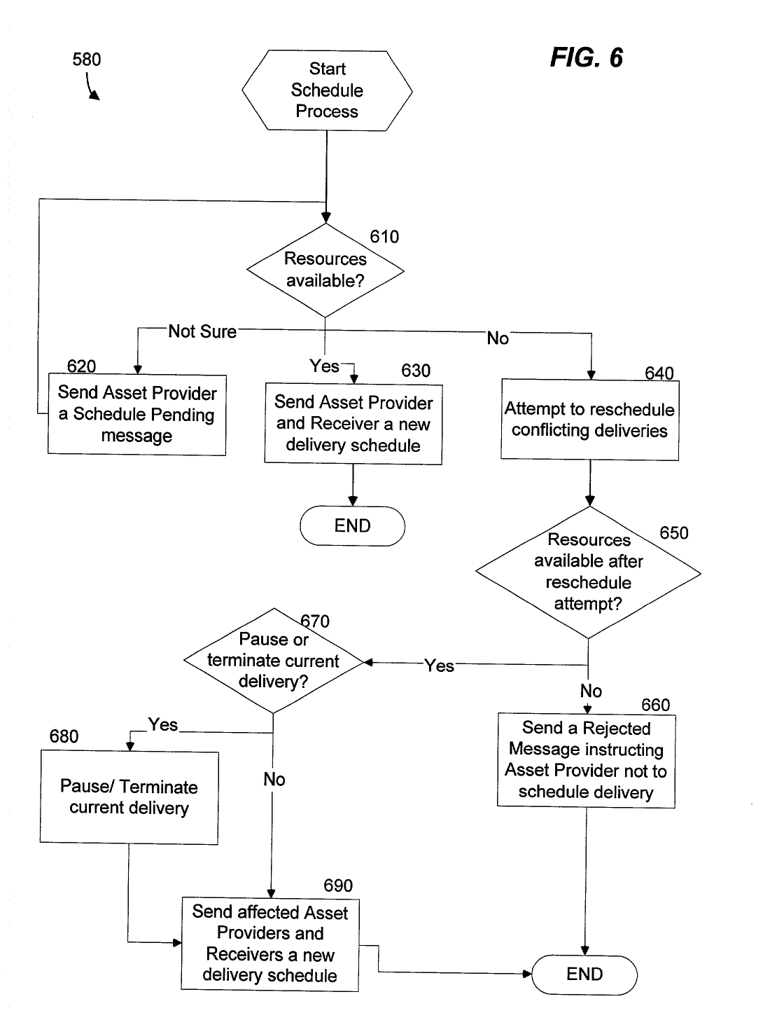

FIG. 5 is a logic flow diagram illustrating an exemplary process 500 for scheduling the distribution of assets by multiple asset providers 10 to multiple receivers 20. Certain steps in the processes described below in FIGS. 5 and 6 must naturally precede others for the present invention to function as described. However, the present invention is not limited to the order of the steps described, if such order or sequence does not alter the functionality of the present invention. It is recognized that some steps may be performed before or after other steps without departing from the scope and the spirit of the present invention.

In Step 510, the scheduler 30 determines whether it has received a request from an asset provider 10 to register the asset provider 10. If the scheduler 30 has not received such a request, then the process branches to Step 530. However, if the scheduler 30 has received a request to register the asset provider 10, then in Step 520, the scheduler 30 registers the asset provider 10. In Step 530, the scheduler 30 determines whether it has received a request to register a receiver 20. If the scheduler 30 has not received a request to register a receiver 20, then the process branches to Step 550. However, if the scheduler 30 has received such a request, then in Step 540, the scheduler 30 registers the receiver 20.

In Step 550, the scheduler 30 determines whether it has received a request to register either another asset provider 10 or another receiver 20. If the scheduler 30 has received such a request, then the process branches to Step 510.

In Step 560, the asset provider 10 determines whether it wants to schedule the delivery of an asset to one or more receivers 20. If an asset provider 10 does not want to schedule the delivery of an asset, then the process branches to Step 510. However, if an asset provider 10 wants to schedule the delivery of an asset to one or more receivers 20, then in Step 570, the asset provider 10 sends an asset delivery request message to the scheduler 30.

In Step 580, in response to receiving a request from an asset provider 10 to schedule the delivery of an asset, the scheduler 30 attempts to schedule the delivery of the asset and sends a new schedule or a new instruction to the asset providers 10 and receivers 20 that are registered with the scheduler 30. In Step 590, in response to receiving an instruction or a new schedule from the scheduler 30, the asset providers 10 implement the new schedule or the new instruction. In Step 595, in response to receiving a new delivery schedule or new instruction from the scheduler 30, the receivers 20 implement the new schedule or instruction.

FIG. 6 is a logic flow diagram illustrating an exemplary sub-process or routine 580 of FIG. 5 for attempting to schedule the distribution of a particular asset by an asset provider 10. Step 610 is the first step in the exemplary process 580 of FIG. 5. In Step 610, the scheduler 30 determines whether the resources requested by the asset provider 10 are available. If the scheduler 30 is unable to determine whether the requested resources will be available, then in Step 620, the scheduler 30 sends the asset provider 10 a “schedule pending” message, and the process branches again to Step 610. However, if the scheduler 30 determines that the requested resources are available, then in Step 630, the scheduler 30 sends the asset providers 10 and the receivers 20 a new delivery schedule 480. If, however, in Step 610, the scheduler 30 has determined that the requested resources are not available, then in Step 640, the scheduler 30 attempts to reschedule the conflicting deliveries.

In Step 650, the scheduler 30 determines whether the requested resources are available after attempting to reschedule the delivery of assets. If the resources are not available even after a reschedule attempt, then in Step 660, the scheduler 30 sends a “rejected” message to the asset provider 10 instructing the asset provider 10 not to schedule the delivery of the asset. However, in Step 650, if the resources become available after the scheduler 30 has attempted to reschedule other deliveries, then in Step 670, the scheduler 30 determines whether an asset provider that is currently sending an asset to a receiver 20 must pause or terminate the delivery as a result of the new schedule. If in Step 670 the scheduler 30 determines that an asset provider 10 must pause or terminate the current delivery of an asset, then in Step 680, the scheduler 30 instructs the asset provider 10 to pause or terminate that delivery of the asset. However, in Step 670, if the asset provider 10 does not need to pause or terminate its current delivery, (or if in Step 680 the scheduler 30 has instructed the asset provider 10 to pause or terminate delivery), then in Step 690 the scheduler 30 sends the asset providers 10 and receivers 20 a new delivery schedule 480 that reflects the changes in the scheduled distribution of assets that results from the scheduler 30 rescheduling the deliveries of assets.

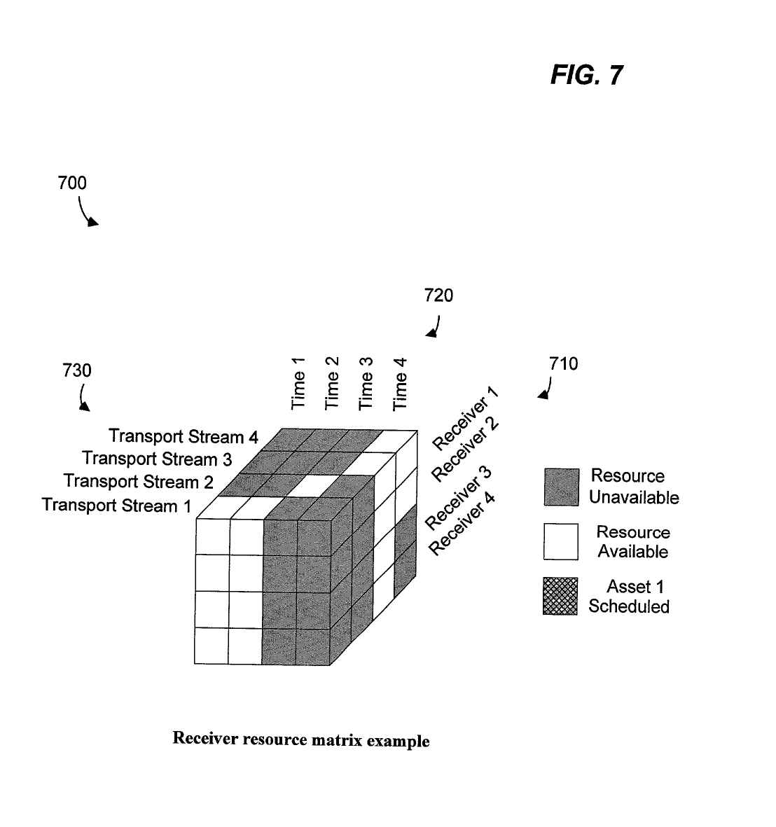

FIG. 7 is an exemplary resource availability matrix 700 built by the scheduler 30 in attempting to schedule the distribution of assets according to one exemplary embodiment of the present invention. In this exemplary embodiment, the network comprises four receivers 710 mapped over four time periods 720. The network also comprises four possible transport streams 730 of the same capacity. This example describes the scheduling of the receiver resources and assumes that the asset providers 10 are able to deliver to all transponders at the required data rate at all times, and all asset delivery requests have the same priority.

Based on the asset provider resource schedules 210 received from the asset providers 10 and the receiver resource schedules 310 received from the receivers 20, the scheduler 30 builds the resource availability matrix 700. The resource availability matrix 700 indicates the following asset delivery avails:

Transport Stream 1, Time 1, All receivers

Transport Stream 1, Time 2, All receivers

Transport Stream 2, Time 3, All receivers

Transport Stream 3, Time 4, All receivers

Transport Stream 4, Time 4, Receivers 1 & 2

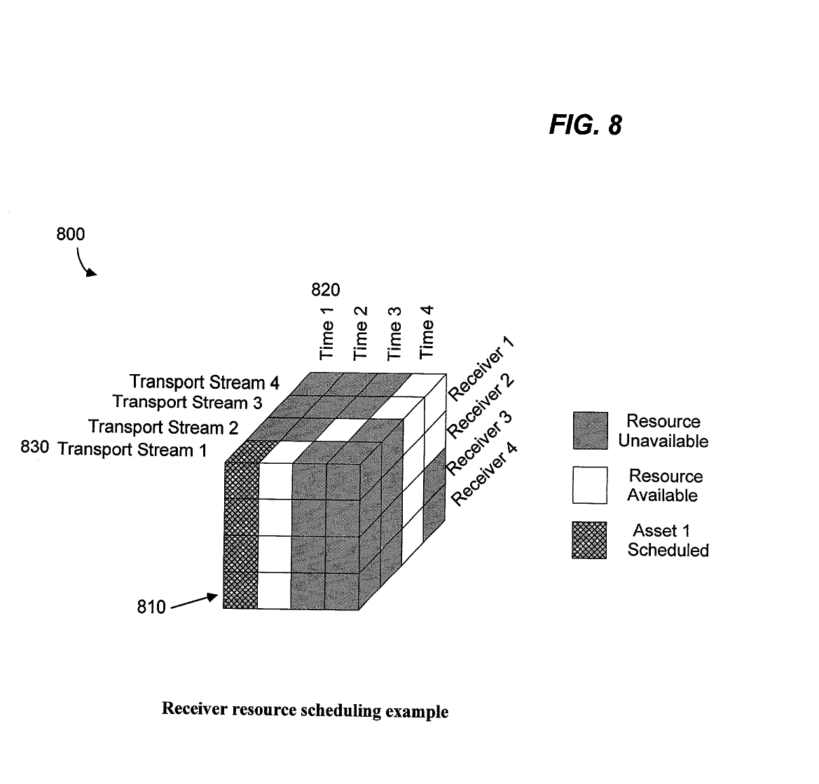

FIG. 8 is an exemplary resource availability matrix 800 illustrating the scheduling of the distribution of a particular asset. Assume the scheduler 30 receives a request from an asset provider 10 to deliver an asset, Asset1 810, that consumes one time period at the given transponder rate. The scheduler 30 tries to find the first available time slice that will satisfy all receivers 20. In this case, Asset1 810 can be scheduled for delivery at Time 1 820, Transport Stream 1 830, since this was the earliest available time.

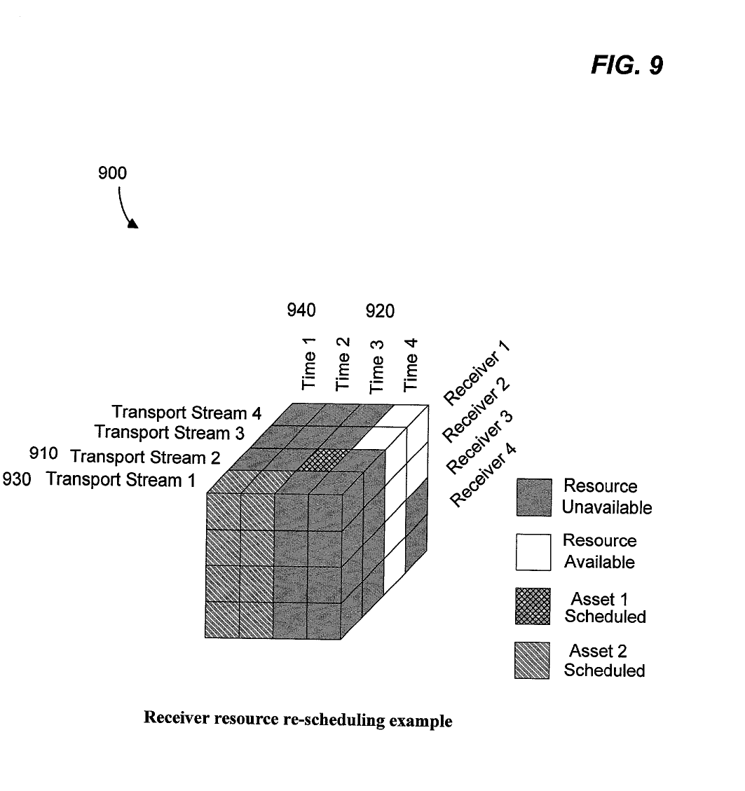

Next, assume the scheduler 30 receives a delivery request for Asset2 with a required delivery time indicating that the delivery must start by Time 4. Asset2 consumes two time periods at the given transponder rate. Since there is no avail large enough to handle Asset2 within the allotted delivery window in the resource availability matrix 800, the scheduler 30 attempts to reschedule its delivery schedule. FIG. 9 is an exemplary resource availability matrix 900 illustrating the rescheduling of scheduled assets to accommodate the distribution of a new asset using the resource availability matrix 900. The scheduler 30 determines that Asset1 can be moved to the next available avail, Transport Stream 2 910 Time 3 920, and still satisfy its delivery window requirements. This frees a contiguous avail, Transport Stream 1 930 Time 1 940, for Asset2.

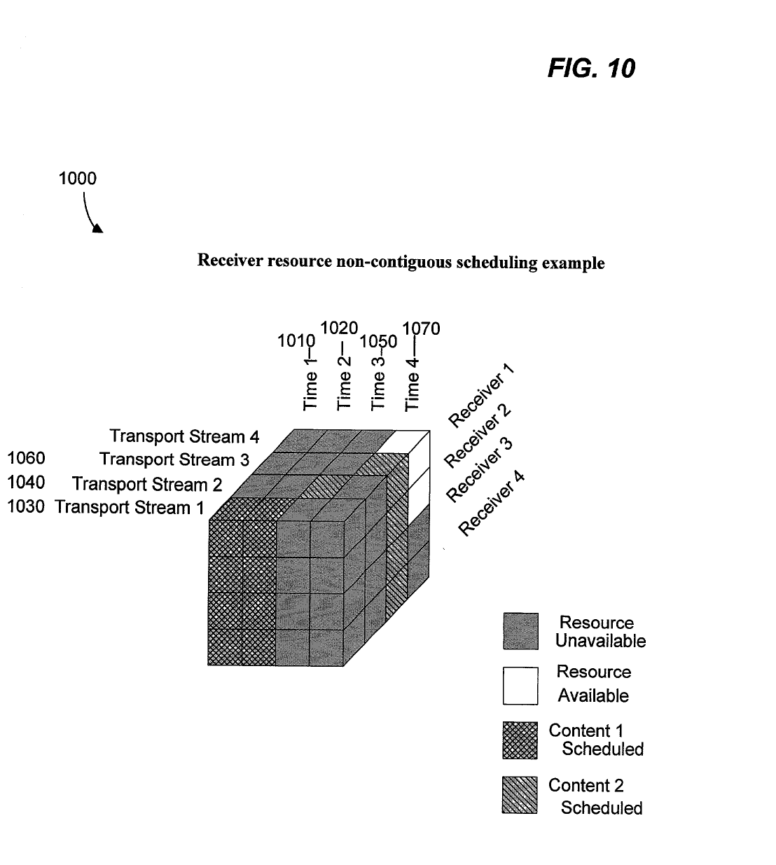

It is not always possible to find contiguous avails for the delivery of assets. If the asset providers 10 and receivers 20 support non-contiguous delivery of assets, the scheduler 30 may have to allocate the delivery of an asset over non-contiguous resources. FIG. 10 is an exemplary resource availability matrix 1000 illustrating the non-contiguous scheduling of the distribution of an asset by the scheduler 30.

In the aforementioned examples, if Asset1 had required two time periods, the scheduler 30 would have scheduled it for Time 1 1010 and Time 2 1020 of Transport Stream 1 1030. Now, when the request from an asset provider 10 to schedule Asset2 was received by the scheduler 30, there would be no contiguous resources available within the allotted delivery times.

In this example, the scheduler 30 can split the delivery of Asset2 between Transport Stream 2 1040, Time 3 1050 and Transport Stream 3 1060, Time 4 1070 to satisfy the delivery requirements.

As shown in these simple examples, the scheduler 30 can attempt to find the best fit between asset delivery requests, asset provider resource schedules 440, and receiver resource schedules 450. Each time an asset delivery request is received by the scheduler 30, the scheduler 30 can recalculate the asset delivery schedule 480 using the criteria defined in the following sections. In one exemplary embodiment of the present invention, a scheduler 30 can use the criteria to determine the asset delivery schedule 480. In order to satisfy all delivery requests, the order of the criteria may be changed to accommodate all requests and meet the delivery schedules 480.

Scheduling Criteria

Required Delivery Time

The scheduler 30 can calculate the amount of time required to deliver an asset. Working backwards from the required delivery date, it can determine the time that the delivery must start in order to meet the required delivery time. The scheduler 30 will not re-schedule an asset beyond this start time.

There are cases when an asset provider 10 with a higher priority or an asset with a higher priority will be scheduled that forces the scheduler 30 to cancel the delivery of an asset. In this case, the asset can be returned to the asset provider delivery request queue 220 and can be re-scheduled by the asset provider 10.

Since the scheduler 30 attempts to deliver assets whenever there is bandwidth available, asset providers 10 should not specify a required delivery time unless they want the asset to be rejected after a certain time. By not specifying a required delivery time, the asset will work its way to the top of the scheduling queue based on the time that it was first scheduled.

There are cases where business arrangements and large volumes of high priority assets use all of the resources of the system 100. In these cases, an asset may never be delivered. The only way to remedy this is to add more resources to the system.

Receiver Footprint

The scheduler 30 attempts to find a time slot when all required receivers 20 are able to receive assets on a transport stream that is available to the asset provider 10. If a time slot cannot be found before the required delivery time, the scheduler 30 may determine that the asset must be sent multiple times. If no required delivery time is specified, the scheduler 30 will continue to move the asset delivery out in time until the asset may be delivered only once. In the case of a satellite delivery network, this means that all receivers 20 must have an Lband input that is receiving the same satellite transponder at the required data rate for the amount of time required to receive the asset.

Asset Provider Priority

After ensuring that all assets can be delivered within the required delivery window, the scheduler 30 can use the asset provider 10 priority to determine which asset will be delivered first. All resources in the system may be assigned an asset provider 10 priority for a given time period. This means that, if an asset provider 10 has an asset to deliver, the scheduler 30 searches the resource schedule during the delivery window for resources that are prioritized for that asset provider 10. If such a resource is found, the scheduler 30 will attempt to use that resource for the delivery of that asset.

An example of this is satellite transponder bandwidth. An asset provider 10 may have the top priority on a transponder during a period of time. The scheduler 30 may use this transponder to deliver the assets of other asset providers 10 if an asset provider 10 with a higher priority does not have any assets to deliver. If an asset is scheduled for delivery on a resource and an asset provider 10 with a higher priority on that resource submits an asset delivery request, the scheduler 30 will re-schedule the asset from the lower priority asset provider 10 to make room for the asset provider 10 with the higher priority.

If a lower priority asset provider 10 is in the process of sending an asset, the scheduler 30 may instruct that asset provider 10 to pause its transmission to allow a higher priority asset provider 10 to deliver its asset. When there are no more assets to send from higher priority asset providers 10, the scheduler 30 can instruct the lower priority asset provider 10 to resume transmission of its asset. If the asset provider 10 and receivers 20 do not support pause and resume transmissions, the scheduler 30 may cancel the transmission to allow a higher priority asset provider 10 to send its asset.

Asset Priority

Each scheduled asset can be assigned a priority. All other criteria being equal, the scheduler 30 can attempt to schedule the delivery of an asset of a higher priority ahead of an asset with a lower priority.

Contractual Rules

The scheduler 30 may be programmed with a set of rules that enforce contractual obligations. For example, a particular asset provider 10 may have exclusive use of a resource over a period of time. The scheduler 30 can apply this rule ahead of all other scheduling concerns. That is, even if the asset provider 10 does not have any asset deliveries scheduled, the scheduler 30 will not use that resource for the contracted time period to schedule other the delivery requests of other asset providers 10.

Earliest Request

Asset delivery requests can be maintained in the asset delivery request queue 470 in the order that they are received. The scheduler 30 can attempt to schedule the oldest requests first. Other factors such as required delivery time, priorities, footprint, etc. may cause an asset to remain at the top of the queue if sufficient resources do not come available to satisfy the request.

It should be understood that the foregoing relates only to illustrative embodiments of the present invention, and that numerous changes may be made therein without departing from the scope and spirit of the invention as defined by the following claims.

What is claimed is:

1. A system for scheduling distribution of an asset using finite resources, the system comprising:
an asset provider, operative to define a first resource schedule comprising a list of the resources available for distributing the asset, to issue a request to schedule the distribution of the asset, and responsive to receiving a delivery schedule, operative to distribute the asset according to the delivery schedule;
a receiver, functionally coupled to the asset provider, operative to define a second resource schedule comprising a list of the resources available for receiving the asset, and responsive to receiving the delivery schedule, operative to allocate the resources for receiving the asset according to the delivery schedule; and
a scheduler, functionally coupled to the asset provider and the receiver, responsive to the request to schedule the distribution of the asset, operative to determine whether the resources are available to distribute the asset using the resources identified in the first resource schedule and the second resource schedule, wherein the scheduler is operative to issue the delivery schedule, if the resources are available, otherwise, the scheduler is operative to reschedule the distribution of other assets to the receiver, if rescheduling is possible.

2. The system of claim 1, wherein the scheduler is further operative to send a message to the asset provider that the distribution of the asset cannot be scheduled, if the resources are not available and the scheduler is not able to reschedule the distribution of the other assets.

3. The system of claim 1, wherein the delivery schedule comprises the resources to be used in distributing the asset and a time at which to distribute the asset.

4. A method for scheduling distribution of assets among asset providers and receivers, wherein the asset providers and the receivers comprise finite resources for distributing the assets, comprising the steps of:
creating a first resource schedule at each asset provider to identify the resources available to distribute the assets;
creating a second resource schedule at each receiver to identify the resources available to receive the assets;
sending a request from one of the asset providers to schedule the distribution of a selected one of the assets to a scheduler, the request identifying at least one receiver to receive the asset;
in response to the request, determining at the scheduler whether the resources are available to distribute the selected asset using the first resource schedule of the asset provider and the second resource schedule of the at least one receiver; and
if the resources are available, sending a delivery schedule from the scheduler to the asset provider and the receiver, the delivery schedule comprising the resources to be used by the asset provider in distributing the asset, the resources to be used by the at least one receiver in receiving the asset, and the time at which to distribute the asset.

5. The method of claim 4, further comprising the steps of:
if the resources are not available, rescheduling the distribution of other assets to accommodate the request, if rescheduling is possible; and
if rescheduling the distribution of other assets is not possible, informing the asset provider that the distribution of the selected asset cannot be scheduled.

6. A system for scheduling the distribution of digital assets among asset providers and at least one receiver, the asset providers and the receiver comprising finite resources, the system comprising:
a scheduler, operative to receive a request from a selected one of the asset providers to schedule the distribution of a selected one of the digital assets to the at least one receiver, and responsive to the request, operative to determine whether the resources of the asset provider and the receiver are available for the distribution of the selected digital asset, wherein the scheduler is operative to schedule the distribution of the selected digital asset, if the resources are available.

7. The system of claim 6, wherein, if the resources are not available, the scheduler is operative to attempt to accommodate the request by rescheduling the distribution of other digital assets to the receiver.

8. The system of claim 7, wherein the scheduler is operative to inform the asset provider that the distribution of the selected digital asset cannot be scheduled, if the distribution of the other digital assets cannot be rescheduled.

9. The system of claim 6, wherein the scheduler comprises a receiver resource schedule for identifying the resources each receiver has available for receiving the digital assets.

10. The system of claim 6, wherein the scheduler comprises an asset provider resource schedule, operative to identify the resources each asset provider has available for distributing the digital assets.

11. The system of claim 6, wherein the scheduler comprises an asset delivery schedule for identifying the digital assets that have been scheduled for distribution by the scheduler.

12. A method for scheduling distribution of assets by asset providers to at least one receiver, wherein the receiver comprises finite resources to receive the assets, comprising the steps of:
receiving a request from a selected one of the asset providers to schedule the distribution of a selected one of the assets to the receiver;
responsive to the request, determining whether the resources of the receiver are available to receive the selected asset using a resource schedule of the receiver, the resource schedule identifying the resources available to the receiver to receive the asset; and
if the resources of the receiver are available, scheduling the distribution of the asset.

13. The method of claim 12, wherein if the resources of the receiver are not available, the method further comprising the step of rescheduling the distribution of other assets to the receiver to accommodate the request, if the distribution of the other assets can be rescheduled.

14. The method of claim 13, further comprising the step of informing the asset provider that the distribution of the selected asset cannot be scheduled, if the distribution of the other assets cannot be rescheduled.

15. The method of claim 13, further comprising the step of sending an asset delivery schedule to the asset providers and the at least one receiver, if the distribution of the other assets can be rescheduled.

16. The method of claim 15, wherein the asset delivery schedule identifies the resources of the at least one receiver that are allocated for receiving the assets scheduled for distribution by the asset providers.

17. The method of claim 15, wherein the sending step comprises suspending the distribution of a selected one of the other assets, if the distribution of the selected asset has been rescheduled and if the asset is presently being distributed by the asset provider.

18. The method of claim 17, wherein the sending step comprises terminating the distribution of the selected one of the other assets, if the distribution of the selected asset could not be rescheduled and if the asset is presently being distributed by the asset provider.

19. A method for scheduling distribution of digital assets by asset providers to at least one cable headend, wherein the cable headend comprises finite resources to receive the digital assets, comprising the steps of:
receiving a request from a selected one of the asset providers to schedule the distribution of a selected one of the digital assets to the cable headend;
responsive to the request, determining whether the resources of the cable headend are available to receive the selected digital asset using a resource schedule of the cable headend, the resource schedule identifying the resources available to the cable headend to receive the digital asset; and
if the resources of the cable headend are available, scheduling the distribution of the digital asset.

20. The method of claim 19, wherein if the resources of the cable headend are not available, the method comprising the step of rescheduling the distribution of other digital assets to the cable headend to accommodate the request, if the distribution of the other digital assets can be rescheduled.

21. The method of claim 20, comprising the step of informing the asset provider that the distribution of the selected digital asset cannot be scheduled, if the distribution of the other digital assets cannot be rescheduled.

22. The method of claim 20, comprising the step of sending an asset delivery schedule to the asset providers and the at least one cable headend, if the distribution of the other digital assets can be rescheduled.

23. The method of claim 22, wherein the asset delivery schedule identifies the resources of the at least one cable headend that are allocated for receiving the digital assets scheduled for distribution by the asset providers.

24. The method of claim 22, wherein the sending step comprises suspending the distribution of a selected one of the other digital assets, if the distribution of the selected digital asset has been rescheduled and if the digital asset is presently being distributed by the asset provider.

25. The method of claim 25, wherein the sending step comprises terminating the distribution of the selected one of the other digital assets, if the distribution of the selected digital asset could not be rescheduled and if the digital asset is presently being distributed by the asset provider.

26. A method for scheduling distribution of digital assets by satellite television providers to at least one satellite set-top box, wherein the satellite set-top box comprises finite resources to receive the digital assets, comprising the steps of:
receiving a request from a selected one of the satellite television providers to schedule the distribution of a selected one of the digital assets to the satellite set-top box;
responsive to the request, determining whether the resources of the satellite set-top box are available to receive the selected digital asset using a resource schedule of the satellite set-top box, the resource schedule identifying the resources available to the satellite set-top box to receive the digital asset; and
if the resources of the satellite set-top box are available, scheduling the distribution of the digital asset.

27. The method of claim 26, wherein if the resources of the satellite set-top box are not available, the method comprising the step of rescheduling the distribution of other digital assets to the satellite set-top box to accommodate the request, if the distribution of the other digital assets can be rescheduled.

28. The method of claim 27, comprising the step of informing the satellite television provider that the distribution of the selected digital asset cannot be scheduled, if the distribution of the other digital assets cannot be rescheduled.

29. The method of claim 27, comprising the step of sending an asset delivery schedule to the satellite television provider, if the distribution of the other digital assets can be rescheduled.

30. The method of claim 29, wherein the asset delivery schedule identifies the resources of the at least one satellite set-top box that are allocated for receiving each digital asset scheduled for distribution by the satellite television providers.

31. The method of claim 29, wherein the sending step comprises suspending the distribution of a selected one of the other digital assets, if the distribution of the selected digital asset has been rescheduled and if the digital asset is presently being distributed by the satellite television provider.

32. The method of claim 31, wherein the sending step comprises terminating the distribution of the selected one of the other digital assets, if the distribution of the selected digital asset could not be rescheduled and if the digital asset is presently being distributed by the satellite television provider.
